(19) United States
(12) Patent Application Publication
(10) Pub. No.: US 2012/0116874 A1
(43) Pub. Date: May 10, 2012

(54) ELECTRONIC ADVERTISING METHOD AND ELECTRONIC APPARATUS

(75) Inventors: Su-Cheng Liu, Hsinchu (TW); Kai-Cheng Chuang, Hsinchu (TW)

(73) Assignee: E INK HOLDINGS INC., Hsinchu (TW)

(21) Appl. No.: 13/350,797

(22) Filed: Jan. 15, 2012

Related U.S. Application Data
(63) Continuation-in-part of application No. 12/683,136, filed on Jan. 6, 2010.

(30) Foreign Application Priority Data
Dec. 2, 2009 (TW) 98141231

(51) Int. Cl. G06Q 30/02

(52) U.S. Cl. 705/14.49

(57) ABSTRACT

An electronic advertising method and an electronic apparatus are provided. In the method, an amount of a factor of the electronic apparatus in executing a task function is accumulated and whether the amount is over a preset value of the electronic apparatus or not is determined. An advertisement is displayed if the amount is over the preset value and a question according to content of the advertisement is displayed. An operation responding an answer to the question is detected and a non-advertisement function is executed if the operation is detected.

### CROSS-REFERENCE TO RELATED APPLICATION

This application is a continuation-in-part of and claims the priority benefit of U.S. application Ser. No. 12/683,136, filed on Jan. 6, 2010, which claims the priority benefit of Taiwan application serial no. 98141231, filed on Dec. 2, 2009. The entirety of each of the above-mentioned patent applications is hereby incorporated by reference herein and made a part of this specification.

### BACKGROUND OF THE INVENTION

1. Field of the Invention

The present invention relates to an advertising method and apparatus, in particular, to an electronic advertising method and an electronic apparatus.

2. Related Art

Electronic paper display uses millions of tiny microcapsules, namely, electronic ink, as optical components to display electronic content on a sheet of plastic film. Each microcapsule contains positively charged white particles and negatively charged black particles suspended in a clear fluid. When a positive or negative electric field is applied, corresponding particles move to the top of the microcapsule where they become visible to the user, which makes the surface of the display sheet appear white or black.

With the development of electronic display technique, the characteristics of the electronic paper display such as high brightness, low power consumption, and flexibility have brought the electronic paper display to be applied to various display applications, especially electronic books (i.e. e-books).

Since the electronic paper display provides reading experience similar to ordinary papers and has an advantage of reusability, it may replace a large amount of reading media including newspapers, magazines, textbooks or any other documents in our daily life. With the popularization of the electronic paper display, the advertisement following the electronic content displayed thereby is considered a huge business opportunity.

### SUMMARY OF THE INVENTION

Accordingly, the present invention is directed to an electronic advertising method and an electronic apparatus, capable of enhancing user's impression on advertisement.

The present invention provides an electronic advertising method, adapted to an electronic apparatus. In the method, an amount of a factor of the electronic apparatus in executing a task function is accumulated and whether the amount is over a preset value of the electronic apparatus or not is determined. An advertisement is displayed if the amount is over the preset value and a question according to content of the advertisement is displayed. An operation responding an answer to the question is detected and a non-advertisement function is executed if the operation is detected.

In an embodiment of the present invention, the factor comprises page-turning times of an e-book.

In an embodiment of the present invention, the step of displaying the advertisement if the amount is over the preset value comprises suspending the execution of the task function and displaying the advertisement, and the step of executing the non-advertisement function comprises executing the non-advertisement function again wherein the non-advertisement function is the task function.

In an embodiment of the present invention, the advertisement is provided to the electronic apparatus along with the installation of the task function and the task function comprises an e-book.

In an embodiment of the present invention, the method further comprises removing, shifting or zooming out the advertisement and the step of removing, shifting or zooming out the advertisement is executed on condition that the answer is correct for the question.

In an embodiment of the present invention, the method further comprises displaying a plurality of answer options of the question.

In an embodiment of the present invention, the operation is performed on at least one of the answer options.

In an embodiment of the present invention, the method further comprises sending a report including user's information and information of the answer to content server providing the advertisement.

In an embodiment of the present invention, the method further comprises detecting an confirming operation performed on the advertisement, and the steps of displaying the question and the plurality of answer options are executed when the confirming operation is detected.

In an embodiment of the present invention, in the step of detecting the operation responding the answer to the question, only a plurality of scan lines of a touch screen within a display area of the answer options are activated.

In an embodiment of the present invention, in the step of detecting the operation responding the answer to the question, a number of activated scan lines of the touch screen is reduced to detect the operation performed on at least one of the answer options.

In an embodiment of the present invention, before displaying the advertisement, the question and the plurality of answer options of the question, the electronic apparatus further downloads or updates the content of the advertisement, the question, and the answer options of the question from a content server.

In an embodiment of the present invention, the method further comprises downloading or updating the content of the advertisement and the question from a content server.

In an embodiment of the present invention, the electronic apparatus comprises an electronic paper display apparatus.

The present invention provides an electronic advertising method, adapted to an electronic apparatus. In the method, a triggering signal for executing a system function is detected. When the triggering signal is detected, an advertisement is displayed and a question according to content of the advertisement is displayed. An operation responding an answer to the question is detected and a non-advertisement function is executed if the operation is detected.

The present invention provides an electronic apparatus, which comprises a display, an input device, an accumulator and an advertisement module. The accumulator is configured to accumulate an amount of a factor of the electronic apparatus when the function module executes a task function. The advertisement module is configured to determine whether the amount is over a preset value of the electronic apparatus or not, make the display show an advertisement if the triggering signal is detected, and make the display show a question according to content of the advertisement. The input device is configured to detect an operation responding an answer to the question, wherein the advertisement module makes the electronic apparatus execute a non-advertisement function if the operation is detected.

In an embodiment of the present invention, the electronic apparatus further comprises a function module, which is configured to execute the task function.

In an embodiment of the present invention, the function module further comprises suspending the execution of the task function, making the display show the advertisement, and executing the non-advertisement function again wherein the non-advertisement function is the task function.

In an embodiment of the present invention, the advertisement module further comprises removing, shifting or zooming out the advertisement.

In an embodiment of the present invention, the advertisement module executes removing, shifting or zooming out the advertisement on condition that the answer is correct for the question.

In an embodiment of the present invention, the advertisement module further makes the display show a plurality of answer options of the question.

In an embodiment of the present invention, the operation is performed on at least one of the answer options.

In an embodiment of the present invention, the electronic apparatus further comprises a communication module, which is configured to connect with a content server to download or update the content of the advertisement, the question, and the answer options of the question in the advertisement module from the content server.

In an embodiment of the present invention, the advertisement module further sends a report including user's information and information of the answer to a content server providing the advertisement.

In an embodiment of the present invention, the input device comprises detecting a confirming operation performed on the advertisement, and the advertisement module comprises making the display show the question and the plurality of answer options when the confirming operation is detected.

In an embodiment of the present invention, the advertisement module only activates a plurality of scan lines of a touch screen within a display area of the answer options, or reduces a number of activated scan lines of the touch screen to detect the operation performed on at least one of the answer options.

The present invention provides an electronic apparatus, which comprises a display, an input device, a function module and an advertisement module. The function module is configured to execute a system function and send out a triggering signal. The advertisement module is configured to make the display show an advertisement when the system function is executed, make the display show a question according to content of the advertisement. The input device is configured to detect an operation responding an answer to the question, wherein the advertisement module makes the electronic apparatus execute a non-advertisement function if the operation is detected.

Based on the above, in the electronic advertising method and electronic apparatus of the present invention, an advertisement is shown when the electronic apparatus is idle for a preset time or about to execute certain system functions. A question and a plurality of answer options related to the advertisement are shown in the advertisement or after the advertisement to enforce the reader to go through the content of the advertisement. Accordingly, user's impression about the advertisement is improved.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the present invention.

FIG. 2 is a flowchart illustrating an electronic advertising method according to an embodiment of the present invention.

FIG. 3 is a flowchart illustrating an electronic advertising method according to an embodiment of the present invention.

FIG. 4 is an example of an electronic advertising method according to an embodiment of the present invention.

FIG. 5 is a block diagram of an electronic apparatus according to an embodiment of the present invention.

FIG. 6 is a flowchart illustrating an electronic advertising method according to an embodiment of the present invention.

FIG. 7 is a block diagram of an electronic apparatus according to an embodiment of the present invention.

FIG. 8 is a flowchart illustrating an electronic advertising method according to an embodiment of the present invention.

FIG. 9 is a block diagram of an electronic apparatus according to a third embodiment of the present invention.

FIG. 10 is a flowchart illustrating an electronic advertising method according to the third embodiment of the present invention.

FIG. 11 is a flowchart illustrating an electronic advertising method according to the third embodiment of the present invention.

### DETAILED DESCREPTION OF THE EMBODIMENTS

To ensure the content of displayed advertisement being passed through by the reader's brain, the present invention displays an advertisement along with a question related to the content of the advertisement. The advertisement is a picture, sign, etc. that is used to make a product or service known and persuade people to buy it. The reader has to go through the content of the advertisement so as to choose a right answer option. Only when the right answer option is chosen, the electronic apparatus resumes the originally displayed frame or executes the system functions triggered by the reader.

The aforesaid advertisement, question, and answer options may be displayed after the reader idles the electronic apparatus for a time period. Due to the everlasting display characteristic of an electronic paper display apparatus, those content can keep displaying without consuming extra power. When the reader picks up the electronic paper display apparatus again, the already displayed advertisement may cause reader's attention, and the displayed question and the answer options may enhance the reader's impression for the content of the advertisement. Accordingly, a better advertising effect is achieved.

### First Embodiment

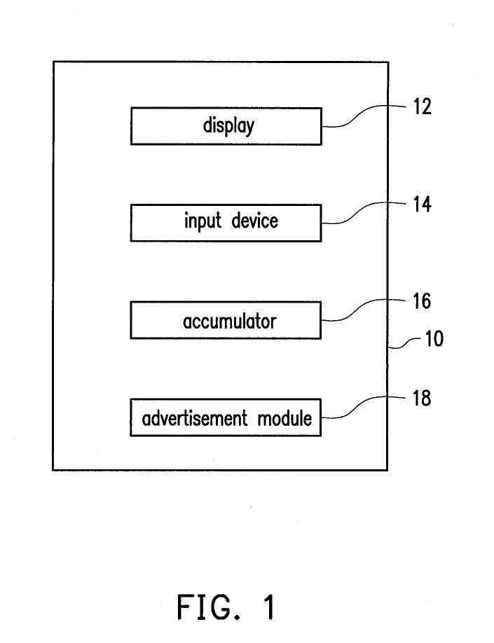

FIG. 1 is a block diagram of an electronic apparatus according to an embodiment of the present invention. Referring to FIG. 1, the electronic apparatus 10 is, for example, an electronic paper display apparatus, a smart phone, a tablet or any other electronic apparatus having a touch screen. The electronic apparatus 10 comprises a display 12, an input device 14, an accumulator 16, and an advertisement module 18, and functions thereof are respectively described below.

The display 12 is, for example, an electronic paper display (EPD), a liquid crystal display (LCD), a light-emitting diode (LED) display, a field emission display (FED) or other kinds of displays. The input device 14 is, for example, a keyboard, a mouse for detecting user's operation. The input device 14 may be a resistive, a capacitive or other kinds of touch sensing devices, which can be integrated with the display 12 to form a touch screen.

The accumulator 16 and the advertisement module 18 are, for example, hardware devices formed by logical circuit components, or software programs stored in a memory or a hard disk of the electronic apparatus 10, which can be loaded into a processor of the electronic apparatus 10 to execute the electronic advertising method of the invention. Examples are provided below for describing functions of the electronic apparatus 10.

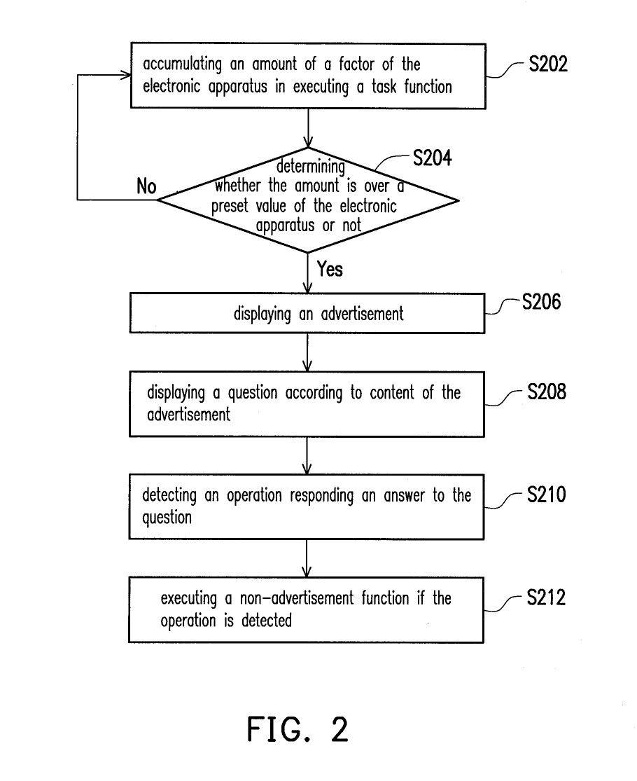

FIG. 2 is a flowchart illustrating an electronic advertising method according to an embodiment of the present invention. Referring to FIGS. 1 and 2, the method according to the present invention is applicable to the electronic apparatus 10 in FIG. 1. Detailed steps of the method according to the present invention are described in detail hereinafter with reference to the elements in FIG. 1.

First, an amount of a factor of the electronic apparatus 10 in executing a task function is accumulated by the accumulator 16 (step S202). Accordingly, the advertisement module 18 may monitor the amount and determine whether the amount is over a preset value (step S204). The aforesaid factor is, for example, page-turning times of an e-book, which is not limited herein.

When the amount is over the preset value, the advertisement module 18 displays an advertisement (step S206) and makes the display 12 show a question according to content of the advertisement (step S208). The displayed advertisement may cover an entire frame or a part of frame (e.g. upper, lower, left, or right edge of the frame) originally displayed on the display 12, so as to draw a user's attention and enforce the user to watch before he/her continues to operate the electronic apparatus 10.

Meanwhile, the input device 14 keeps detecting an operation and the advertisement module 18 determines whether an operation responding an answer to the question is detected (step S210). In the present embodiment, the aforesaid advertisement and question are simultaneously displayed. However, in another embodiment, the advertisement and question may be sequentially displayed. To be specific, the advertisement is displayed first when the amount is over the preset value, and the question is displayed next when a confirming operation performed on the advertisement is detected.

In the step 210, if an operation responding an answer to the question is detected, the advertisement module 18 executes a non-advertisement function (step S212).

It is noted herein that, the aforesaid task function is, for example, an e-book or any other applications executed by the electronic apparatus 10, and the content of the aforesaid advertisement may be related to the task function executed by the electronic apparatus 10. The non-advertisement function is, for example, a function the same as the task function or another application that the user intends to execute, which is not limited herein. In addition to the non-advertisement function, the electronic apparatus 10 may further remove, shift or zoom the advertisement on condition that the answer is correct for the question.

In addition, in the step S206, when the amount is over the preset value, the advertisement module 18 may further suspend the execution of the task function and then execute the task function again if an operation responding an answer to the question is detected in step S212.

### Second Embodiment

For commercial purpose, the advertisements may be provided along with the purchase of the electronic apparatus 10. That is to say, the advertisements are previously stored in a database built in the electronic apparatus 10 by a manufacturer and are updated thereafter, so as to be directly displayed in an appropriate occasion.

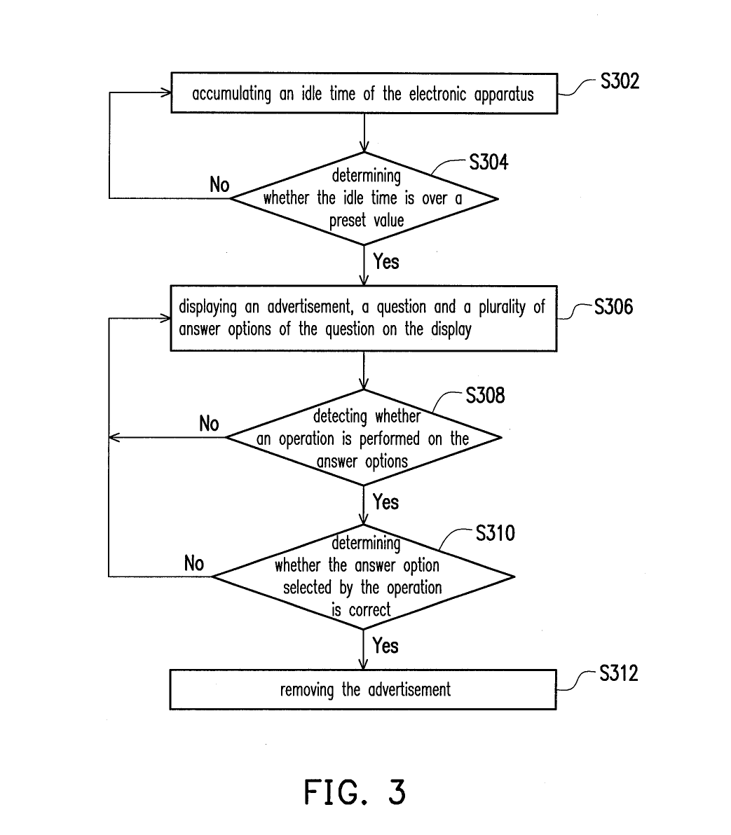

In detail, FIG. 3 is a flowchart illustrating an electronic advertising method according to an embodiment of the present invention. Referring to FIGS. 1 and 3, the method according to the present invention is applicable to the electronic apparatus 10 in FIG. 1. Detailed steps of the method according to the present invention are described in detail hereinafter with reference to the elements in FIG. 1.

First, when a user stops operating the electronic apparatus 10, the accumulator 16 is triggered to accumulating an idle time of the electronic apparatus 10 (step S302). Accordingly, the advertisement module 18 may monitor the idle time and determine whether the idle time is over a preset value (step S304).

When the idle time is over the preset value, the advertisement module 18 makes the display 12 show an advertisement, a question and a plurality of answer options of the question (step S306). The displayed advertisement may cover an entire frame or a part of frame (e.g. upper, lower, left, or right edge of the frame) originally displayed on the display 12, so as to draw a user's attention and enforce the user to watch before he/her continues to operate the electronic apparatus 10. The question and the answer options of the question may be a public opinion investigation, a market investigation or any other exercise related to the content of the advertisement or user's interest.

Meanwhile, the input device 14 keeps detecting an operation and the advertisement module 18 determines whether the operation is detected on one of the answer options (step S308). In the present embodiment, the aforesaid advertisement, question, and answer options are simultaneously displayed. However, in another embodiment, the advertisement, question, and answer options may be sequentially displayed. To be specific, the advertisement is displayed first when the idle time is over the preset value, and the question and the answer options of the question are displayed next when the operation is detected on the advertisement.

In the step 308, if an operation is detected on one of the answer options, the advertisement module 18 continues to determine whether the answer option selected by the operation is correct or not (step S310). If the selected answer option is determined as correct, the advertisement module 18 removes the advertisement (step S312) so as to resume the frame originally displayed on the display 12. On the other hand, if the selected answer option is determined as incorrect, the flow is returned to step S306, and the advertisement module 18 may still display the original advertisement, the question, and the answer options, or the advertisement module 18 may change to display another advertisement, question, and answer options, which is not limited herein.

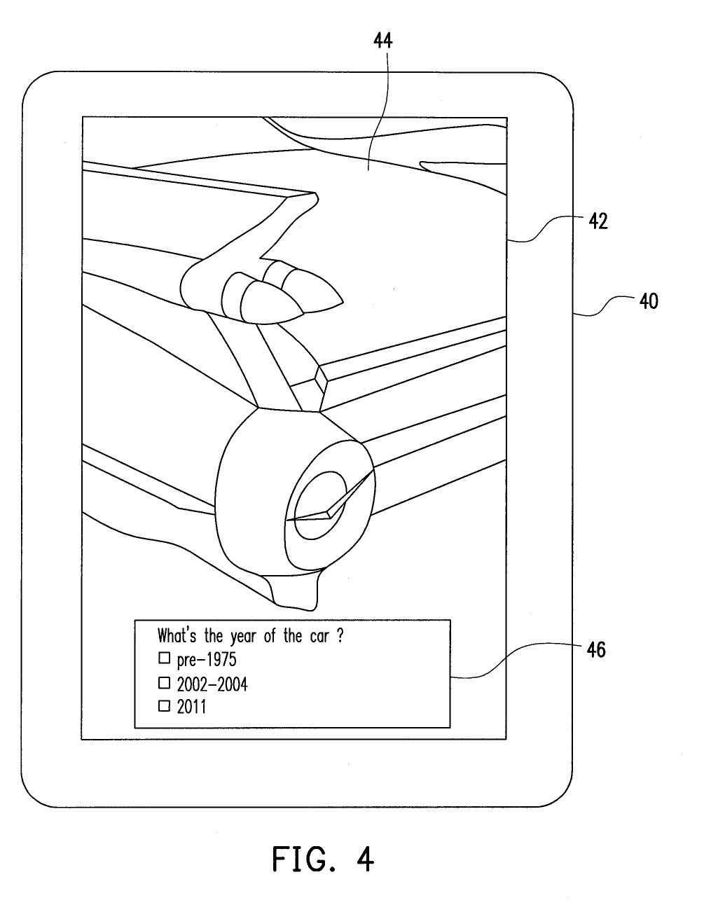

FIG. 4 is an example of an electronic advertising method according to an embodiment of the present invention. Referring to FIG. 4, when the electronic apparatus 40 is idle for a preset time, an advertisement 44 about a car is displayed on the display 42 and covers the originally displayed frame. Meanwhile, a window 46 comprising a question and a plurality of answer options is also displayed in a lower part of the advertisement 44. The question “What's the year of the car?” is related to the car displayed in the advertisement 44. Through the reading of the advertisement 44, a reader may easily choose “pre-1975” as the answer. The question may enhance reader's impression about the content presented by the advertisement 34, and therefore a better advertising effect is achieved.

It is noted herein that the advertisements may be provided along with the functions to be executed by the electronic apparatus or the electronic content to be displayed by the electronic apparatus. The advertisements are provided while the electronic apparatus installs the function. An embodiment is given below for further illustration.

### Third Embodiment

For commercial purpose, the manufacturer of electronic apparatus, or its cooperative content provider or advertiser may provide various free or non-free applications or electronic content for users to download. In providing the free or discounted content, the content provider may request for a trade-off as showing advertisements. That is to say, an advertisement may show up when the user execute the application or see the electronic content. Accordingly, a better advertising effect is achieved.

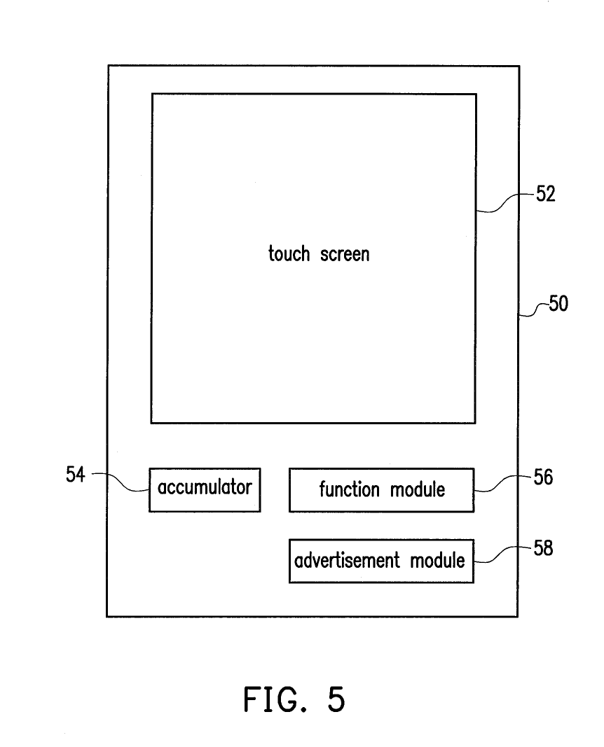

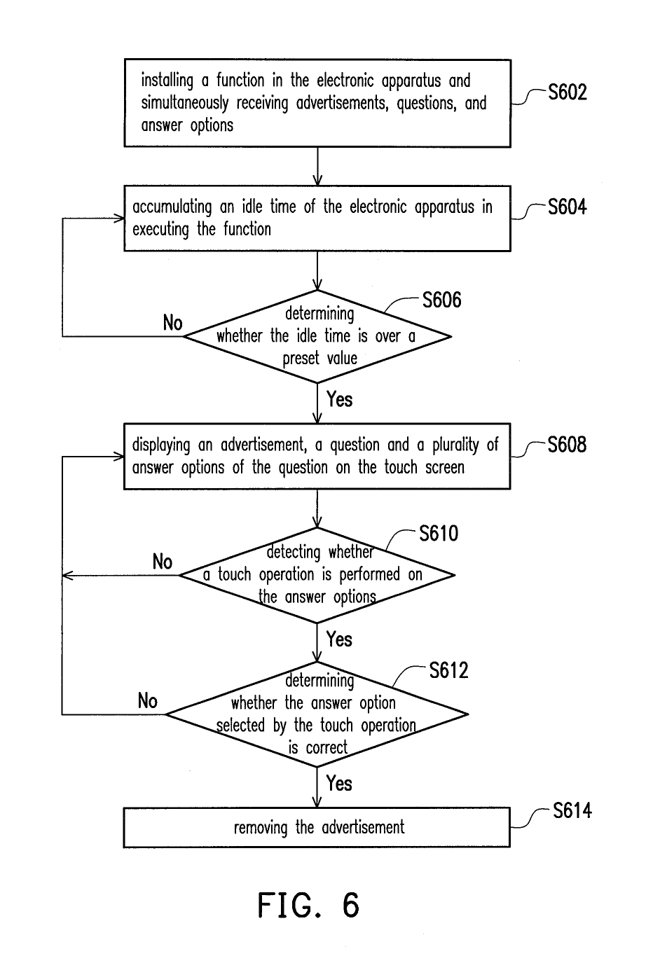

FIG. 5 is a block diagram of an electronic apparatus according to an embodiment of the present invention. FIG. 6 is a flowchart illustrating an electronic advertising method according to an embodiment of the present invention. Referring to FIGS. 5 and 6, the electronic apparatus 50 is, for example, an electronic paper display apparatus, a smart phone, a tablet or any other electronic apparatus having a touch screen. The electronic apparatus 50 comprises a touch screen 52, an accumulator 54, a function module 56, and an advertisement module 58. The touch screen 52 is used as an exemplary tool in the present embodiment and may be replaced with a display and an input device as described in the first embodiment, which is not limited herein. Detailed steps of the method according to the present invention are described in detail hereinafter with reference to the elements in FIG. 5.

First, the electronic apparatus 50 downloads and installs a function in a function module 56 and simultaneously receives a plurality of advertisements, questions, and answer options (step S602). The function is, for example, an application or an electronic content such as a newspaper, a magazine, or an e-book.

When the function module 56 executes the function, the accumulator 54 is triggered to accumulating an idle time of the electronic apparatus 50 (step S604). Accordingly, the advertisement module 58 determines whether the idle time is over a preset value (step S606).

When the idle time is over the preset value, the advertisement module 48 makes the touch screen 52 show an advertisement, a question and a plurality of answer options of the question (step S608). Meanwhile, the touch screen 52 keeps detecting a touch operation and the advertisement module 58 determines whether the touch operation is detected on one of the answer options (step S610).

If a touch operation is detected on one of the answer options by the touch screen 52, the advertisement module 58 continues to determine whether the answer option selected by the touch operation is correct or not (step S612). If the selected answer option is determined as correct, the advertisement module 58 removes the advertisement (step S614) so as to resume the frame originally displayed on the touch screen 52. If no touch operation is detected in step S610 or the selected answer option is determined as incorrect in step S612, the flow is returned to step S608.

Based on the above, the user can have free authorization to use the function, the content provider can gain profits from the advertiser, and the advertiser can obtain better advertising effect, a win-win deal is realized.

### Fourth Embodiment

Some electronic apparatuses or software applications may request the user to enter personal information in the first utilization, which provides the content provider with a chance to correlate the answer of a user with his/her personal information. The correlated information may help the content provider to investigate users' behavior and accordingly improve the service for the content. An embodiment is described below for further illustration.

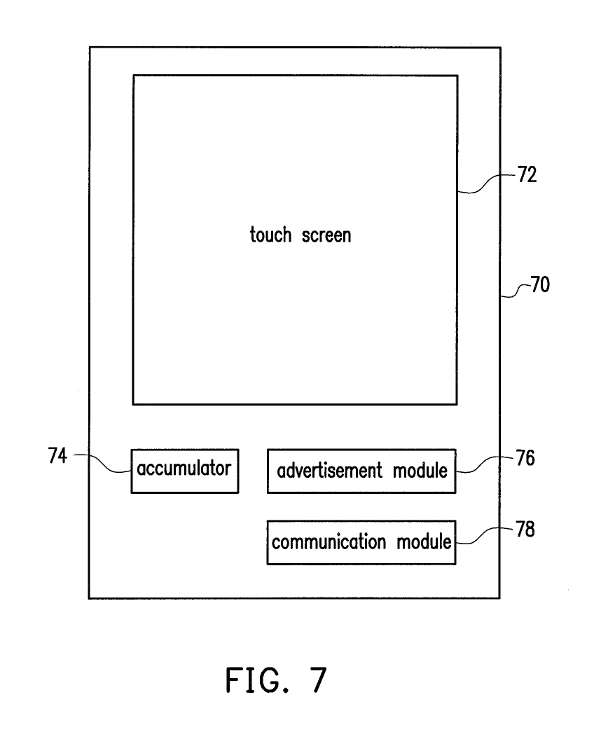

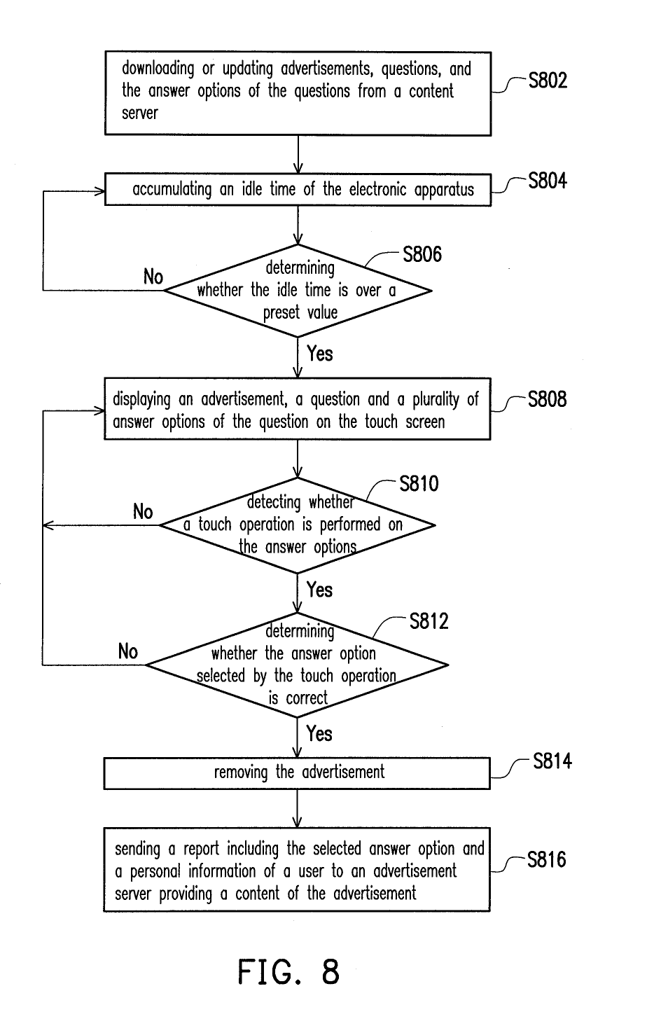

FIG. 7 is a block diagram of an electronic apparatus according to an embodiment of the present invention. FIG. 8 is a flowchart illustrating an electronic advertising method according to an embodiment of the present invention. Referring to FIGS. 7 and 8, the electronic apparatus 70 is, for example, an electronic paper display apparatus, a smart phone, a tablet or any other electronic apparatus having a touch screen. The electronic apparatus 70 comprises a touch screen 72, an accumulator 74, an advertisement module 76, and a communication module 78. The touch screen 72 is used as an exemplary tool in the present embodiment and may be replaced with a display and an input device as described in the first embodiment, which is not limited herein. Detailed steps of the method according to the present invention are described in detail hereinafter with reference to the elements in FIG. 7.

First, the advertisement module 76 downloads or updates a plurality of advertisements, questions, and answer options of the questions from a content server by the communication module 78 (S802). The advertisement module 76 may be previously built in the electronic apparatus 70 by a manufacturer. The communication module 78 may be a wireless module supporting a mobile communication (GSM) system, a personal handy-phone system (PHS), a code division multiple access (CDMA) system, a wireless fidelity (Wi-Fi) system, or a worldwide interoperability for microwave access (WiMAX) system, etc., which provides a wireless network connection to the content server.

After the user purchases the electronic apparatus 70, whenever the electronic apparatus 70 is in an alive state, the advertisement module 76 may periodically connect to the content server through the communication module 78 to check whether an update of the electronic content is available for download. If there is an update, the advertisement module 76 downloads the update and stores the downloaded update in a memory or a hard disk of the electronic apparatus 70.

Accordingly, when a user stops operating the electronic apparatus 70, the accumulator 74 is triggered to accumulating an idle time of the electronic apparatus 70 (step S804). Accordingly, the advertisement module 76 determines whether the idle time is over a preset value (step S806).

When the idle time is over the preset value, the advertisement module 76 makes the touch screen 72 show an advertisement, a question and a plurality of answer options of the question (step S808). Meanwhile, the touch screen 72 keeps detecting a touch operation and the advertisement module 76 determines whether the touch operation is detected on one of the answer options (step S810).

If a touch operation is detected on one of the answer options by the touch screen 72, the advertisement module 76 continues to determine whether the answer option selected by the touch operation is correct or not (step S812). If the selected answer option is determined as correct, the advertisement module 76 removes the advertisement (step S814) so as to resume the frame originally displayed on the touch screen 72. If no touch operation is detected in step S810 or the selected answer option is determined as incorrect in step S812, the flow is returned to step S808.

In addition to remove the advertisement, the advertisement module 76 also sends a report including the answer option selected by the user and a personal information of the user to the content server providing the content of the advertisement (step S816). Accordingly, useful information about user's behavior can be obtained by the content provider.

The aforesaid method may be applied to a public opinion investigation, a market investigation or any other kinds of investigations, and the report returned to the content provider may help the manufacturer, the content provider, or the advertiser to do advanced investigation.

### Fifth Embodiment

In the present embodiment, an advertisement, a question, and answer options thereof are shown each time a user turning pages of an e-book for a preset number of times. The display of the advertisement may help the user to have a break in reading the e-book, and the content of the advertisement and the question may be related to the already read pages of the e-book or related to the investigation provided by the content provider. Accordingly, a better advertising effect is achieved.

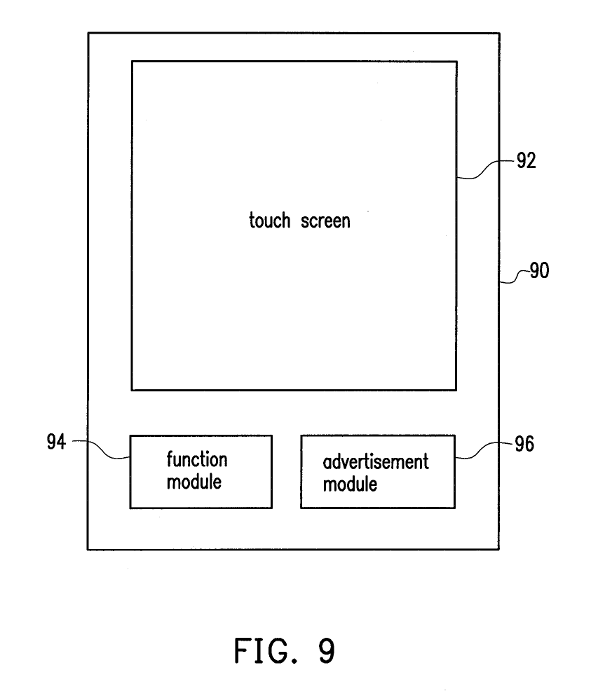

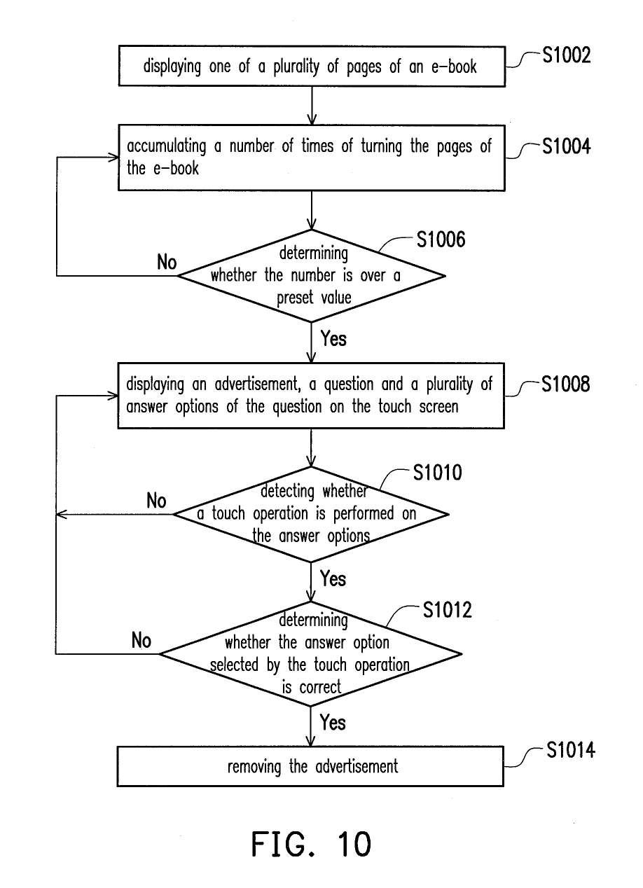

FIG. 9 is a block diagram of an electronic apparatus according to a third embodiment of the present invention. FIG. 10 is a flowchart illustrating an electronic advertising method according to the third embodiment of the present invention. Referring to FIGS. 9 and 10, the electronic apparatus 90 is, for example, an electronic paper display apparatus, a smart phone, a tablet or any other electronic apparatus having a touch screen. The electronic apparatus 90 comprises a touch screen 92, a function module 94, and an advertisement module 96. The touch screen 92 is used as an exemplary tool in the present embodiment and may be replaced with a display and an input device as described in the first embodiment, which is not limited herein. Detailed steps of the method according to the present invention are described in detail hereinafter with reference to the elements in FIG. 9.

First, the function module 94 displays one of a plurality of pages of an e-book (step S1002). The e-book is, for example, an application previously installed in the function module 94, and the content of the e-book may be stored in the electronic apparatus 90 when installing the application or may be updated each time the user executes the application, which is not limited herein.

When the user reads the e-book, the function module 94 accumulates a number of page-turning of the e-book (step S1004), and determines whether the number is over a preset value (step S1006). In one embodiment, the aforesaid number may be a fixed value (e.g 5 or 10) predetermined by the function module 94. In another embodiment, the number may be a various value determined according to the chapters or sections of the e-book. For example, the number may be determined according to the page count of each chapter such that when the user finishes reading one chapter, an advertisement is displayed before proceeding to a next chapter.

When the number is over the preset value, the advertisement module 96 makes the touch screen 92 show an advertisement, a question and a plurality of answer options of the question (step S1008). Meanwhile, the touch screen 92 keeps detecting a touch operation and the advertisement module 96 determines whether the touch operation is detected on one of the answer options (step S1010).

If a touch operation is detected on one of the answer options by the touch screen 92, the advertisement module 96 continues to determine whether the answer option selected by the touch operation is correct or not (step S1012). If the selected answer option is determined as correct, the advertisement module 96 removes the advertisement (step S1014) so as to resume the frame originally displayed on the touch screen 92. If no touch operation is detected in step S1010 or the selected answer option is determined as incorrect in step S1012, the flow is returned to step S1008.

### Sixth Embodiment

In the present embodiment, an advertisement, a question, and answer options thereof are shown each time a user executes a system function such as booting up the electronic apparatus or shutting down the electronic apparatus. Accordingly, a better advertising effect is achieved.

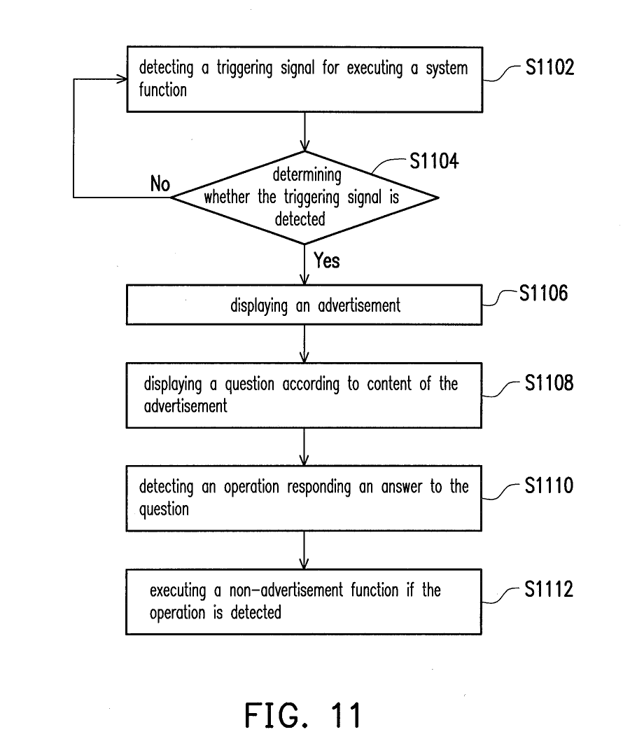

FIG. 11 is a flowchart illustrating an electronic advertising method according to the third embodiment of the present invention. Referring to FIGS. 9 and 11, the method of the present embodiment is also adapted to the electronic apparatus 90 of FIG. 9. Detailed steps of the method according to the present invention are described in detail hereinafter with reference to the elements in FIG. 9.

First, the advertisement module 96 detects a triggering signal for executing a system function provided by the function module 94 (step S1102). The system function is, for example, a boot-up function, a shut-down function, an idle function, a sleep function, or a hibernate function. The system function may be triggered through a hardware key of the electronic apparatus 90 or through a software key or function item shown on the touch screen 92 of the electronic apparatus 90, which is not limited herein.

The advertisement module 96 determines whether the triggering signal is detected or not (step S1104). When the triggering signal is detected, the advertisement module 96 makes the touch screen 92 show an advertisement (step S1106) and show a question according to content of the advertisement (step S1108).

It is noted herein that, in another embodiment, a short break may be inserted between the trigger of the system function and the display of the advertisement. Accordingly, when the triggering signal is detected, the advertisement module 96 first accumulates an amount of a factor of the electronic apparatus and then makes the touch screen 92 show the advertisement, the question and the plurality of answer options of the question when the amount is determined over a preset value.

Back to step S1106, in the meantime of displaying the advertisement and the question, the touch screen 92 keeps detecting a touch operation and the advertisement module 96 determines whether an operation responding an answer to the question is detected (step S1110).

If the operation is detected, the advertisement module 96 executes a non-advertisement function (step S1110). The non-advertisement function is, for example, an application that the user intends to execute, which is not limited herein.

It is noted herein that, to save the power consumed by the touch screen, the scan lines of the touch screen used to detect the touch operation may be reduced during the display of the advertisement, the question, and the answer options. To be specific, in one embodiment, the electronic apparatus may only activates the scan lines of the touch screen within a display area of the answer options, so as to detect the touch operation performed on the answer options. In another embodiment, the electronic apparatus may reduce a number of activated scan lines of the touch screen, so as to detect the touch operation performed on at least one of the answer options. The aforesaid method may be applied to all embodiments described above, thus saving the power of the electronic apparatus.

To sum up, in the electronic advertising method and electronic apparatus of the present invention, the advertisement previously installed in or instantly updated by an electronic apparatus are displayed when the electronic apparatus is idle for a preset time or when the electronic apparatus executes specific functions. The concurrently displayed question enforces the user to go through the content of the advertisement and therefore the user's impression for the advertisement is enhanced. Besides, the answer and the personal information of the user are combined and fed back to the content provider, thus helping to investigate user's behavior. Accordingly, a better advertising effective or investigation result is obtained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic advertising method, adapted to an electronic apparatus, the method comprising:
accumulating an amount of a factor of the electronic apparatus in executing a task function;
determining whether the amount is over a preset value of the electronic apparatus or not;
displaying an advertisement if the amount is over the preset value;
displaying a question according to content of the advertisement;
detecting an operation responding an answer to the question; and
executing a non-advertisement function if the operation is detected.

2. The electronic advertising method as claimed in claim 1, wherein the factor comprises page-turning times of an e-book.

3. The electronic advertising method as claimed in claim 1, wherein the step of displaying the advertisement if the amount is over the preset value comprises:
suspending the execution of the task function and displaying the advertisement, and
wherein the non-advertisement function is the same as the task function.

4. The electronic advertising method as claimed in claim 1, wherein the advertisement is provided to the electronic apparatus along with the installation of the task function.

5. The electronic advertising method as claimed in claim 1, wherein the task function comprises an e-book.

6. The electronic advertising method as claimed in claim 1, further comprising removing, shifting or zooming out the advertisement.

7. The electronic advertising method as claimed in claim 6, wherein the step of removing, shifting or zooming out the advertisement is executed on condition that the answer is correct for the question.

8. The electronic advertising method as claimed in claim 1, further comprising:
displaying a plurality of answer options of the question.

9. The electronic advertising method as claimed in claim 8, wherein the operation is performed on at least one of the answer options.

10. The electronic advertising method as claimed in claim 9, wherein the step of detecting the operation responding the answer to the question comprises:
reducing a number of activated scan lines of a touch screen to detect the operation performed on at least one of the answer options.

11. The electronic advertising method as claimed in claim 8, further comprising:
detecting an confirming operation performed on the advertisement, and
wherein the steps of displaying the question and the plurality of answer options are executed when the confirming operation is detected.

12. The electronic advertising method as claimed in claim 8, wherein the step of detecting the operation responding the answer to the question comprises:
only activating a plurality of scan lines of a touch screen within a display area of the answer options.

13. The electronic advertising method as claimed in claim 1, further comprising:
sending a report including user's information and information of the answer to a content server providing the advertisement.

14. The electronic advertising method as claimed in claim 1, further comprising:
downloading or updating the content of the advertisement and the question from a content server.

15. The electronic advertising method as claimed in claim 1, wherein the electronic apparatus is an electronic paper display apparatus.

16. An electronic advertising method, adapted to an electronic apparatus, the method comprising:
detecting a triggering signal for executing a system function;
displaying an advertisement if the triggering signal is detected;
displaying a question according to content of the advertisement;
detecting an operation responding an answer to the question; and
executing a non-advertisement function if the operation is detected.

17. The electronic advertising method as claimed in claim 16, wherein the system function comprises a boot-up function, a shut-down function, an idle function, a sleep function, or a hibernate function.

18. The electronic advertising method as claimed in claim 16, wherein the step of displaying the advertisement if the triggering signal is detected comprises:
after the triggering signal is detected, accumulating an amount of a factor of the electronic apparatus;
determining whether the amount is over a preset value of the electronic apparatus or not; and
displaying the advertisement when the amount is over the preset value.

19. The electronic advertising method as claimed in claim 18, wherein the factor comprises an idle time of the electronic apparatus.

20. The electronic advertising method as claimed in claim 16, further comprising removing, shifting or zooming out the advertisement.

21. The electronic advertising method as claimed in claim 20, wherein the step of removing, shifting or zooming out the advertisement is executed on condition that the answer is correct for the question.

22. The electronic advertising method as claimed in claim 16, further comprising:
displaying a plurality of answer options of the question.

23. The electronic advertising method as claimed in claim 22, wherein the operation is performed on at least one of the answer options.

24. The electronic advertising method as claimed in claim 23, wherein the step of detecting the operation responding the answer to the question comprises:
reducing a number of activated scan lines of a touch screen to detect the operation performed on at least one of the answer options.

25. The electronic advertising method as claimed in claim 22, further comprising:
detecting an confirming operation performed on the advertisement, and wherein the steps of displaying the question and the plurality of answer options are executed when the confirming operation is detected.

26. The electronic advertising method as claimed in claim 22, wherein the step of detecting the operation responding the answer to the question comprises:
only activating a plurality of scan lines of a touch screen within a display area of the answer options.

27. The electronic advertising method as claimed in claim 16, further comprising:
sending a report including user's information and information of the answer to a content server providing the advertisement.

28. The electronic advertising method as claimed in claim 16, further comprising:
downloading or updating the content of the advertisement and the question from a content server.

29. The electronic advertising method as claimed in claim 16, wherein the electronic apparatus is an electronic paper display apparatus.

30. An electronic apparatus, comprising:
a display;
a function module;
an accumulator, configured to accumulate an amount of a factor of the electronic apparatus when the function module executes a task function;
an advertisement module, configured to determine whether the amount is over a preset value of the electronic apparatus or not, make the display show an advertisement if the amount is over a preset value of the electronic apparatus, and make the display show a question according to content of the advertisement; and
an input device, configured to detect an operation responding an answer to the question, wherein the function module execute a non-advertisement function if the operation is detected.

31. The electronic apparatus as claimed in claim 30, wherein the factor comprises page-turning times of an e-book.

32. The electronic apparatus as claimed in claim 30, wherein the function module is further configured to suspend the execution of the task function if the amount is over the preset value, and wherein the non-advertisement function is the same as the task function.

33. The electronic apparatus as claimed in claim 30, wherein the advertisement is provided to the advertisement module along with the installation of the task function.

34. The electronic apparatus as claimed in claim 30, wherein the task function comprising an e-book.

35. The electronic apparatus as claimed in claim 30, wherein the advertisement module is further configured to remove, shift or zoom out the advertisement.

36. The electronic apparatus as claimed in claim 35, wherein the advertisement module executes removing, shifting or zooming out the advertisement on condition that the answer is correct for the question.

37. The electronic apparatus as claimed in claim 30, wherein the advertisement module further makes the display show a plurality of answer options of the question.

38. The electronic apparatus as claimed in claim 37, wherein the input device is further configured to detect a confirming operation performed on the advertisement, and the advertisement module is further configured to make the display show the question and the plurality of answer options when the confirming operation is detected.

39. The electronic apparatus as claimed in claim 37, wherein the advertisement module only activates a plurality of scan lines of a touch screen within a display area of the answer options.

40. The electronic apparatus as claimed in claim 37, wherein the operation is performed on at least one of the answer options.

41. The electronic apparatus as claimed in claim 40, wherein the advertisement module reduces a number of activated scan lines of a touch screen to detect the operation performed on at least one of the answer options.

42. The electronic apparatus as claimed in claim 37, further comprises:
a communication module, configured to connect with a content server to download or update the content of the advertisement, the question, and the answer options of the question in the advertisement module from the content server.

43. The electronic apparatus as claimed in claim 30, wherein the advertisement module further sends a report including user's information and information of the answer to a content server providing the advertisement.

44. The electronic apparatus as claimed in claim 30, wherein the electronic apparatus comprises an electronic paper display apparatus.

45. An electronic apparatus, comprising:
a display;
a function module, configured to execute a system function and send out a triggering signal;
an advertisement module, configured to make the display show an advertisement if the triggering signal is detected, and make the display show a question according to content of the advertisement; and
an input device, configured to detect an operation responding an answer to the question, wherein the function module execute a non-advertisement function if the operation is detected.

46. The electronic apparatus as claimed in claim 45, wherein the system function comprises a boot-up function, a shut-down function, an idle function, a sleep function, or a hibernate function.

47. The electronic apparatus as claimed in claim 45, further comprising:
an accumulator, configured to accumulate an amount of a factor of the electronic apparatus after the triggering signal is detected, wherein the advertisement module further determines whether the amount is over a preset value of the electronic apparatus or not, and make the display show the advertisement when the amount is over the preset value of the electronic apparatus.

48. The electronic apparatus as claimed in claim 47, wherein the factor comprises an idle time of the electronic apparatus.
